(19) United States
(12) Patent Application Publication
(10) Pub. No.: US 2013/0301919 A1
(43) Pub. Date: Nov. 14, 2013

(54) SELECTION FEATURES FOR IMAGE CONTENT

(71) Applicant: Song Lin, Milpitas, CA (US)

(72) Inventor: Song Lin, Milpitas, CA (US)

(73) Assignee: Google Inc.

(21) Appl. No.: 13/470,056

(22) Filed: May 11, 2012

(51) Int. Cl. G06K 9/18

(52) U.S. Cl. 382/182

(57) ABSTRACT

A method for serving content based on a selection feature for a campaign includes receiving an image associated with particular content and analyzing the image content of the image to derive a selection feature from the image. The selection feature is descriptive of image content. The method further includes identifying at least one keyword based on the selection feature. The method further includes associating the at least one keyword with the particular content and storing the particular content and its associated at least one keyword for serving in response to a content request.

### BACKGROUND

The present disclosure relates generally to the field of content display. More specifically, the present disclosure relates to extraction of selection features in image content.

A content provider may provide content for display on a webpage. The content shown may be selected such that the most relevant content to a user browsing the webpage is shown. The content provider may wish to set up a campaign, which allows the content provider to have its content presented on one or more websites or other media. In order to set up a campaign, selection features (e.g., keywords) may be specified that facilitate determining when content may be considered relevant by the user.

### SUMMARY

One implementation of the present disclosure relates to a method for serving content based on a selection feature for a campaign. The method includes receiving an image associated with particular content and analyzing the image content of the image to derive a selection feature from the image. The selection feature is descriptive of image content. The method further includes identifying at least one keyword based on the selection feature. The method further includes associating the at least one keyword with the particular content and storing the particular content and its associated at least one keyword for serving in response to a content request.

Another implementation of the present disclosure relates to a computer readable medium having instructions stored therein, the instructions being executable by one or more processors to cause the one or more processors to perform operations. The operations include receiving an image associated with particular content and analyzing the image content of the image to derive a selection feature from the image. The selection feature is descriptive of image content. The operations further include identifying at least one keyword based on the selection feature. The operations further include associating the at least one keyword with the particular content and storing the particular content and its associated at least one keyword for serving in response to a content request.

Another implementation of the present disclosure relates to a system for serving content based on a selection feature for a campaign. The system includes a processing circuit operable to receive an image associated with particular content and analyze the image content of the image to derive a selection feature from the image, wherein the selection feature is descriptive of image content. The processing circuit is further operable to identify at least one keyword based on the selection feature. The processing circuit is further operable to associated the at least one keyword with the particular content and store the particular content and its associated at least one keyword for serving in response to a content request.

Another implementation of the present disclosure relates to a method for serving content based on a selection feature for a campaign. The method includes receiving a first image and a user search term associated with the first image. The method further includes analyzing the image content of the first image to derive a selection feature from the image, wherein the image feature is descriptive of first image content. The method further includes comparing the selection feature of the first image to selection images of a set of other images and determining a match between the selection feature of the first image and a selection feature of a second image from the set of images. The method further includes determining at least one keyword based on the user search term and associating the at least one keyword with the second image.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a computer system in accordance with a described implementation.

FIG. 2 is a more detailed block diagram of a feature suggestion system of the content source of FIG. 1 in accordance with a described implementation.

FIG. 3A is an example illustration of content in accordance with a described implementation.

FIG. 3B is an example data flow diagram of extracting selection features from the content of FIG. 3A in accordance with a described implementation.

FIG. 4A is a flow chart of a process for serving content based on selection features for a campaign in accordance with a described implementation.

FIG. 4B is a flow chart of a process for determining selection features in accordance with a described implementation.

FIG. 4C is a flow chart of a process for determining selection features in accordance with another described implementation.

### DETAILED DESCRIPTION OF THE ILLUSTRATIVE EMBODIMENTS

Referring generally to the figures, systems and methods for generating selection features for image content, such as image advertisements, are shown and described. Using image processing techniques, selection features may be extracted from image content. The selection features may be text extracted from the image content, such as information or keywords related to the extracted text or other features extracted from the image. The selection features may then be used to help set up a campaign for a content provider. For example, the selection features may be used as keywords and may be used to identify other related selection features (e.g., other related keywords) to be used for the image content in a campaign for serving content (e.g., an advertising campaign). The campaign may allow the image content to be displayed on websites or other media channels, and the selection features extracted may be used to help select the websites and other media channels. For example, an advertisement may be selected for display on a website based on a selection feature that indicates that the advertisement is suitable for display on the website.

In one implementation, optical character recognition (OCR) is used to extract text from the image content. The extracted text may then be used as a selection feature (e.g., the extracted text may be used as one or more keywords for the campaign). For example, if the image content is a car advertisement, the advertisement may contain text specifying the make and model of the car, and OCR may be used to extract the make and model from the content. The make and model may then be used as keywords for the content.

Further, various processing may be performed to identify additional selection features. In one implementation, after text is extracted from an image content, context clustering is used to analyze the text. Context clustering may be used to identify words that have a meaning that is similar to the extracted words. In other words, new keywords, phrases, or other selection features may be determined based on the original selection features using such context clustering. For example, if the content is an advertisement that contains text specifying the make and model a German car, and that make and model is a mid-size car, context clustering may be used to identify “German mid-size car” as an additional selection feature for the image content. As another example, terms that have a similar meaning to “car” may be identified, such as “automobile,” “vehicle,” and so on.

In another implementation, after text is extracted from an image content, the meaning of the text may be abstracted to a higher level topic using a taxonomy. For example, if a taxonomy has been defined that includes the term “car” at one node, the term “sportscar” at a node one level down, and various makes/models of sports cars at various nodes yet another level down in the taxonomy, then such a taxonomy may be used to generate additional selection features. For example, if the content is an advertisement that contains text specifying the make and model a German car, and that make and model is a sports car, then additional selection features may be identified by moving up vertically in the taxonomy. For example, the terms “car” or “sportscar” may be identified as additional selection features.

In another implementation, after text is extracted from an image content, additional complementary terms may be determined. For example, lists may be defined that contain such complementary terms and may be accessed to generate additional selection features. For example, if the content is an advertisement that contains text specifying the make and model a German car, additional complementary terms such as “dealership,” “leasing,” “new cars,” “used cars,” and so on, may be generated.

In another implementation, other features may be extracted from the image and used to generate selection features. For example, in some instances, the image may have been returned to one or more previous users as part of search results for an image search. If the image is a match of an image content of a content provider, the search keywords that led the previous users to find and click on the image in the image search results may be stored as a selection feature of the image content. The search keywords may further be used in the post-processing techniques described above.

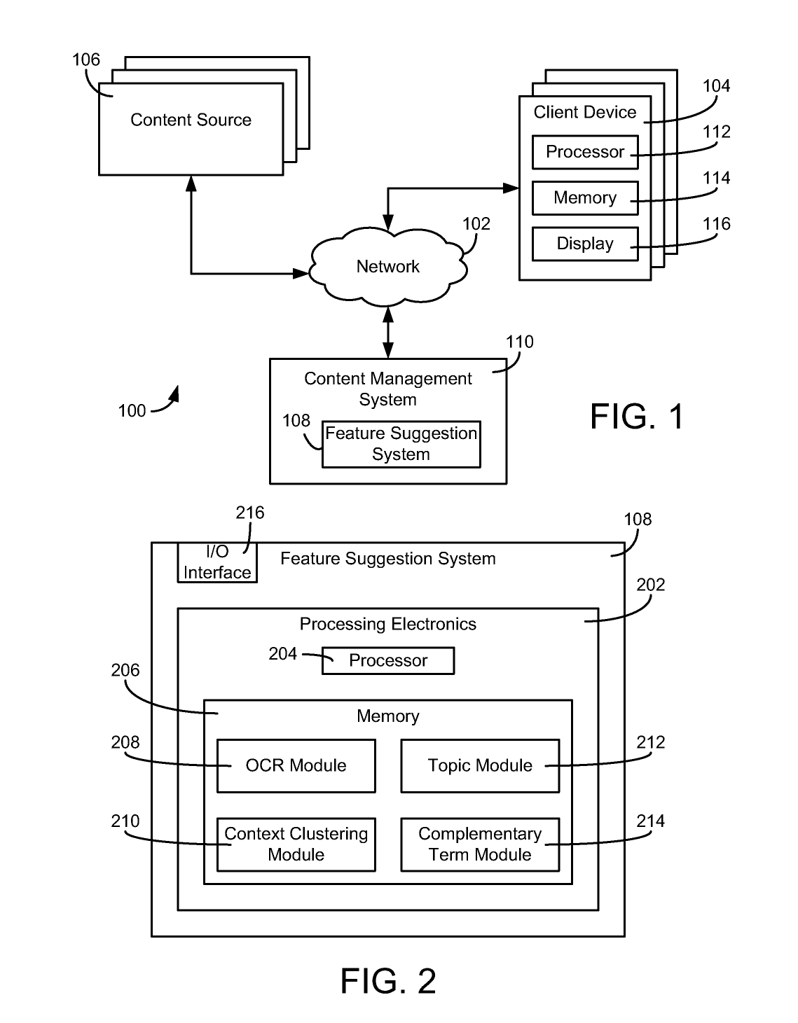

Referring now to FIG. 1, a block diagram of a computer system 100 in accordance with a described implementation is shown. Computer system 100 includes one or more client devices 104 which communicate with other computing devices via a network 102. Client device 104 may execute a web browser or other application to retrieve content from other devices via network 102. For example, client device 104 may communicate with any number of content sources 106. Content sources 106 may provide webpage data and/or other content (e.g., text documents, PDF files, and other forms of electronic documents) to a client device 104. In some implementations, computer system 100 may also include a content management system 110 configured to manage content provided to client devices 104 by content sources 106 or another source connected to network 102. In general, computer system 100 is shown as an illustrative system that selects content for display on client devices 104 using selection features of the content.

Network 102 may be any form of computer network that relays information between content sources 106 and client devices 104. For example, network 102 may include the Internet and/or other types of data networks, such as a local area network (LAN), a wide area network (WAN), a cellular network, satellite network, or other types of data networks. Network 102 may also include any number of computing devices (e.g., computers, servers, routers, network switches, etc.) that are configured to receive and/or transmit data within network 102. Network 102 may further include any number of hardwired and/or wireless connections. For example, client device 104 may communicate wirelessly (e.g., via WiFi, cellular, radio, etc.) with a transceiver that is hardwired (e.g., via a fiber optic cable, a CAT5 cable, etc.) to other computing devices in network 102.

Client device 104 may be any number of different types of user electronic devices configured to communicate via network 106 (e.g., a laptop computer, a desktop computer, a mobile phone or other mobile device, a tablet computer, a smartphone, a digital video recorder, a set-top box for a television, a video game console, combinations thereof, etc.). Client device 104 is shown to include a processor 112 and memory 114, i.e., a processing circuit. Memory 114 may store machine instructions that, when executed by processor 112 to cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python, and Visual Basic.

Client device 104 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client device 104 (e.g., a built-in display, microphone, etc.) or external to the housing of client device 104 (e.g., a monitor or speaker connected to client device 104, etc.), according to various implementations. For example, client device 104 may include an electronic display 116, which displays webpages and other data received from content sources 106 and/or content management system 110.

Content sources 106 may be one or more electronic devices connected to network 102 that provide content to client devices 104. For example, content sources 106 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, and other forms of electronics documents.

According to various implementations, content sources 106 may provide webpage data to client devices 104 that includes one or more content tags. In general, a content tag may be any piece of webpage code associated with including content with a webpage. According to various implementations, a content tag may define a slot on a webpage for additional content, a slot for out of page content (e.g., an interstitial slot), whether content should be loaded asynchronously or synchronously, whether the loading of content should be disabled on the webpage, whether content that loaded unsuccessfully should be refreshed, the network location of a content source that provides the content (e.g., content sources 106, content management system 110, etc.), a network location (e.g., a URL) associated with clicking on the content, how the content is to be rendered on a display, one or more keywords used to retrieve the content, and other functions associated with providing additional content with a webpage. For example, content sources 106 may provide webpage data that causes client devices 104 to retrieve an advertisement from content management system 110. In another implementation, the advertisement may be selected by content management system 110 and provided by a content source 106 as part of the webpage data sent to client device 104.

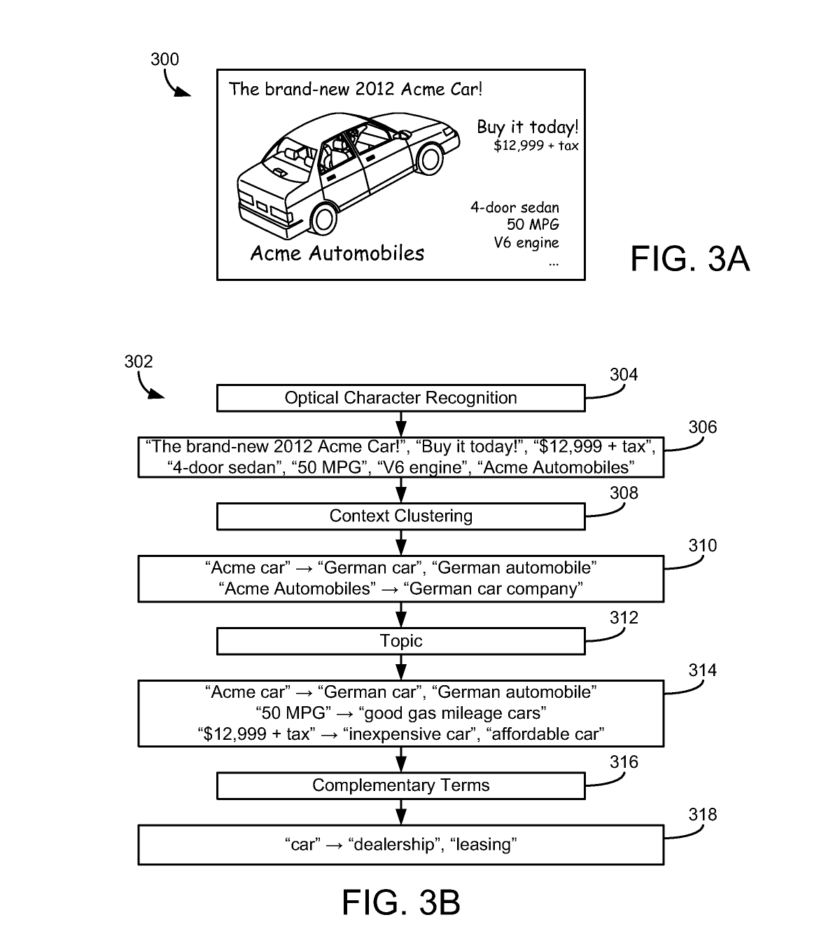

Similar to content sources 106, content management system 110 may be one or more electronic devices connected to network 102 that provide advertisements and/or other content to client devices 104. Content management system 110 may be a computer server (e.g., FTP servers, file sharing servers, web servers, etc.) or a combination of servers (e.g., a data center, a cloud computing platform, etc.). Content management system 110 may include a processing circuit including a processor and memory as described above. The processing circuit of content management system 110 may be configured to select content to provide to a client device 104 or to provide content sources 106 with information allowing the content sources 106 to select content to provide to a client device 104. For example, content management system 110 may select content, such as an advertisement, to be provided with a webpage served by content sources 106. Content management system 110 includes a feature suggestion system 108. Feature suggestion system 108 may derive or extract selection features from content. Feature suggestion system 108 is described in greater detail in FIG. 2.

Content selected by content management system 100 may be provided to a client device 104 by content sources 106 or content management system 110. For example, content management system 100 may select content from content sources 106 to be included with a webpage served by a content source 106. In another example, content management system 110 may provide the selected content to a client device 104. In some implementations, content management system 110 may select content stored in memory 114 of a client device 104. The content may be selected based on selection features, in accordance with one implementation. For example, content management system 110 may select content, such as an advertisement, if the content has one or more selection features associated with the content, the selection features may be used to determine whether to provide the content to client device 104.

The selection of content may further be based on a user identifier associated with client device 104. The user identifier may refer to any form of data that may be used to represent a user that has opted into receiving relevant content selected by content management system 110. In some implementations, a user identifier may be associated with a client identifier that identifies a client device to content management system 110 or may itself be the client identifier. In some implementations, a user identifier may be associated with multiple client identifiers (e.g., a client identifier for a mobile device, a client identifier for a home computer, etc.). Client identifiers may include, but are not limited to, cookies, device serial numbers, user profile data, telephone numbers, or network addresses. For example, a client identifier associated with client device 104 may be used to identify client device 104 and the client to content management system 110. In some cases, the client identifier, the user identifier, or both may be anonymized.

In the implementation of the present disclosure, the user may opt in or opt out of sharing information. For example, the user may opt into receiving relevant content selected by content management system 104, or may opt out of receiving the content. Further, the user may choose whether or not to share information such as a user identifier, client identifier, user browsing history information, user impressions, and other information that may be used by a content management system 104 or other system to select content to display to the user. The user may choose to remain private (e.g., sharing no such information) or may choose to share all or some of the information as described in the present disclosure. The systems and methods of the present disclosure may be executed upon verifying that a user has opted into receiving content from content management system 104 and has opted into sharing user-related information.

Content management system 110 may use information associated with a user identifier to select relevant content for the user identifier. For example, content management system 110 may analyze history data associated with a user identifier to determine one or more potential interest categories for the user identifier. History data may be any data associated with a user identifier that is indicative of an online action (e.g., visiting a webpage, selecting an advertisement, navigating to a webpage, making a purchase, downloading content, etc.). Advertisers and other content providers that have content matching an interest category of a user identifier may select content to be provided to a device associated with the user identifier. For example, content management system 110 may select content to be displayed with a certain webpage by client device 104.

The content provided by content sources 106 may be advertisements. The advertisements may be image advertisements, flash advertisements, video advertisements, text-based advertisements, or any combination thereof. It should be understood that while the present disclosure is implemented for image advertisements, the type of advertisement or other content displayed via a client device 104 may vary according to various implementations. Feature suggestion system 108 is configured to determine feature suggestions for content (e.g., image advertisements) that allow content source 106 to determine content to provide to client devices 104.

Computer system 100 is illustrated as an example environment for use with the systems and methods of the present disclosure; in various implementations, computer system 100 may include more or less systems and modules for use with the systems and methods of the present disclosure.

Referring now to FIG. 2, a more detailed block diagram of feature suggestion system 108 is shown, according to an exemplary embodiment. Feature suggestion system 108 is configured to extract selection features from content (e.g., image advertisements). Selection features may generally include information about the content that allows the content management system 110 to select when to provide the content to a client device for display to a user. Feature suggestion system 108 may generally be configured to extract information from the content and to process the information to determine selection features. The content and selection features may then be provided to a content management system 110 or another system that selects the content for display on a client device based on the selection features.

Feature suggestion system 108 includes processing electronics 202 including a processor 204 and memory 206. Processor 204 may be implemented as a general purpose processor, an application specific integrated circuit (ASIC), one or more field programmable gate arrays (FPGAs), a group of processing components, or other suitable electronic processing components. Memory 206 is one or more devices (e.g., RAM, ROM, Flash memory, hard disk storage, etc.) for storing data and/or computer code for completing and/or facilitating the various processes described herein. Memory 206 may be or include non-transient volatile memory or non-volatile memory. Memory 206 may include data base components, object code components, script components, or any other type of information structure for supporting the various activities and information structures described herein. Memory 206 may be communicably connected to processor 204 and includes computer code or instructions for executing one or more processes described herein.

Memory 206 includes various modules for completing the methods described herein. It should be understood that memory 206 may include more or less modules, and that some of the activity described as occurring within memory 206 and processing electronics 202 may be completed by modules located remotely from feature suggestion system 108 or processing electronics 202.

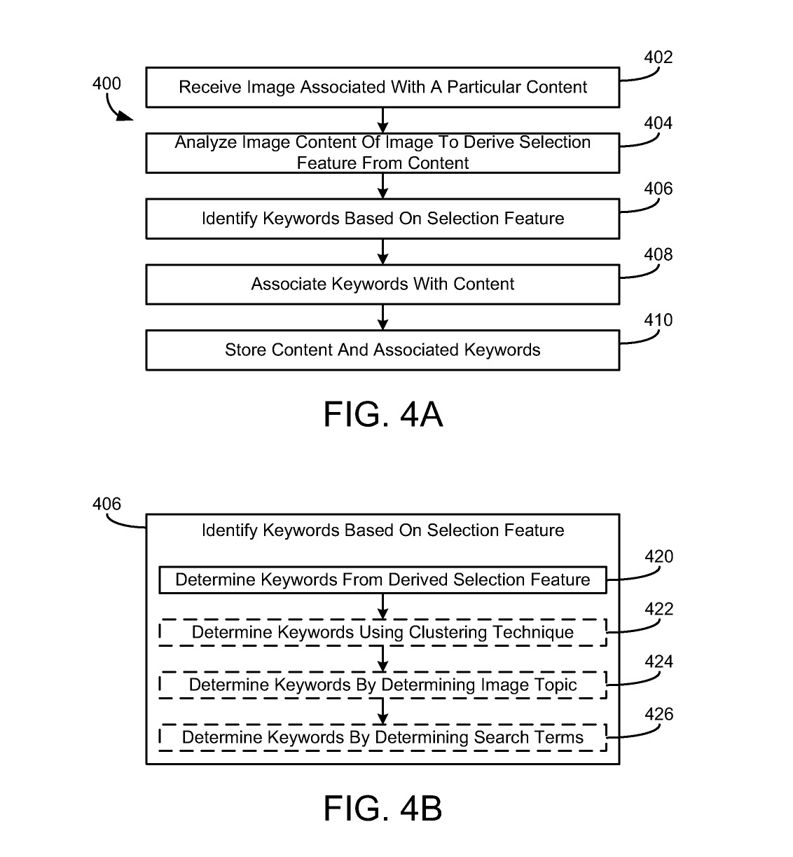

Memory 206 includes a feature recognition module 208 that is configured to receive content (e.g., an image advertisement) and to analyze image content of the image to derive a selection feature from the image. The image content analysis may involve analyzing the visual appearance of the image (i.e., what the image looks like to a human observer). In this context, merely accessing any meta data that might be associated with the image is, by itself, not considered analyzing image content of the image. According to one implementation, the feature recognition module is an optical character recognition (OCR) module. For example, also referring to FIG. 3A, an example of an image of content is shown in the form of a car advertisement 300. OCR module 208 may be configured to extract all text shown in advertisement 300.

Upon extracting the text, OCR module 208 may further designate the extracted text as a keyword. For example, also referring to FIG. 3A, the text “Acme Automobiles” and “2012 Acme Car” that is extracted from advertisement 300 may be used as keywords. The keywords are then used as selection features for the advertisement (e.g., advertisement 300 may be selected for display on a webpage based on the keywords “Acme Automobiles” or “2012 Acme Car”). As another example, the image of the car in advertisement 300 may be analyzed by OCR module 208 and keywords such as “automobile” may be assigned based on the recognition of the car. As yet another example, module 208 may analyze advertisement 300 and identify the tires of the car, and keywords may be assigned to advertisement 300 based on the tire identification (e.g., car tires).

OCR module 208 may further be configured to extract features other than text in an image. For example, OCR module 208 may extract a shape such as the car shown in FIG. 3A, and then determine that the derived or extracted shape is a car. While the implementation of the present disclosure described OCR module 208 as extracting text from an image, it should be appreciated that OCR module 208 may extract other image visuals without departing from the scope of the present disclosure.

Memory 206 further includes context clustering module 210. Context clustering module 210 is configured to use a clustering technique to analyze the text extracted by OCR module 208. In general, a word cluster may be a set of words that convey the same or similar ideas. A word cluster may be a set of synonyms, according to one implementation. For example, a word cluster that includes the word “car” may be as follows:

cluster_{—}1={car, automobile, sedan, passenger vehicle, motor car, coupe}

In some cases, a word cluster may include words that have related, but different meanings By using the clustering technique, the extracted text may be interpreted accurately and used to generate additional related selection features (e.g., additional keywords).

Referring to FIG. 3A and advertisement 300, one example implementation of a clustering technique may be to identify a cluster that contains the keyword “Acme car.” Then, similar word concepts to “Acme car” may be determined by module 310. For example, if “Acme” is a German brand, then the phrases “German car” and “German automobile” may be determined to be in the same cluster as “Acme car” by module 310. The new phrases may then be used as keywords and selection features for the advertisement.

Memory 206 further includes topic module 212. Topic module 212 is configured to abstract the text extracted by OCR module 208 to a higher level topic using a taxonomy. The taxonomy may have multiple levels, allowing the text to be abstracted to varying levels of abstraction. For example, the taxonomy may include a topic “good gas mileage cars” with sublevels consisting of varying miles per gallon ratings. Hence, the “50 MPG” text in advertisement 300 may be abstracted to the topic of “good gas mileage cars.” This allows content management system 110 to provide the advertisement to a webpage when it is determined that a car advertisement featuring a car with good gas mileage would be appropriate to show.

Memory 206 further include complementary term module 214. Complementary term module 214 is configured to identify related terms that closely relate to and often appear with the text extracted by module 208. For example, if the advertisement contains text relating to cars, additional complementary terms such as “dealership,” “leasing,” “new cars,” “used cars,” and so on, may be generated. The complementary terms may represent an expansion of the extracted text to include similar words and/or may be terms simply similar to the extracted text.

Referring now to FIG. 3B, the activities of modules 208-214 are shown in greater detail via data flow diagram 302. Data flow diagram 302 illustrates the activities of modules 208-214 with reference to example image advertisement 300. First, OCR is used to extract text from image advertisement 300 at block 304. At block 306, the results of extracting text from image advertisement 300 is shown. For example, the following text is extracted: “The brand-new 2012 Acme Car!,” “Buy it today!”, “$12,999+tax”, “4-door sedan”, “50 MPG”, “V6 engine”, and “Acme Automobiles.” The extracted text is then used as keywords and selection features for the advertisement.

Next, at block 308, context clustering may be performed on the text. For example, the text “automobiles,” “car,” and “sedan” may be clustered together. At block 310, after context clustering, additional keywords related to the text are determined. For example, as a result of the context clustering of the text “automobiles,” “car,” and “sedan,” “German car” and “German automobile” are determined to be keywords based on the text “Acme car,” and “German car company” is determined as a keyword based on the text “Acme Automobiles.” These keywords may then be used as selection features for image advertisement 300.

Next, at block 312, the topic of the extracted text may be determined. At block 314, the determined topics of the text are shown and can be used as keywords and selection features. For example, “German car” and “German automobile” may be determined to be keywords based on the text “Acme car,” which is determined as a topic at block 312. Further, the text “50 MPG” may indicate that the car gets good gas mileage, and therefore “good gas mileage cars” or a similar description may be determined as a topic at block 312 and used as a topic of the advertisement. Further, the text “$12,999+tax” may indicate that the car is affordable compared to other cars. Therefore “inexpensive car” and “affordable car” or a similar description may be determined as a topic of the advertisement at block 312.

Next, at block 316, complementary terms related to the extracted text may be determined. At block 318, the determined search terms are used as keywords and selection features. For example, “dealership” and “leasing” are determined as search terms related to “car.”

It should be understood that the process described in FIG. 3B may include additional steps or omit steps. For example, a content source may only wish to use context clustering and not determine a topic or search terms. Any combination of the steps shown in diagram 302 may be used to determine keywords and selection features for content such as advertisement 300.

Referring again to FIG. 2, feature suggestion system 120 includes an input/output (I/O) interface 216 configured to receive data from various client devices and to transmit content (e.g., advertisements and advertisement information) to the various client devices as described above. I/O interface 216 is configured to facilitate communications, either via a wired connection or wirelessly, with the client device, network, content management system, and other devices as described in the present disclosure.

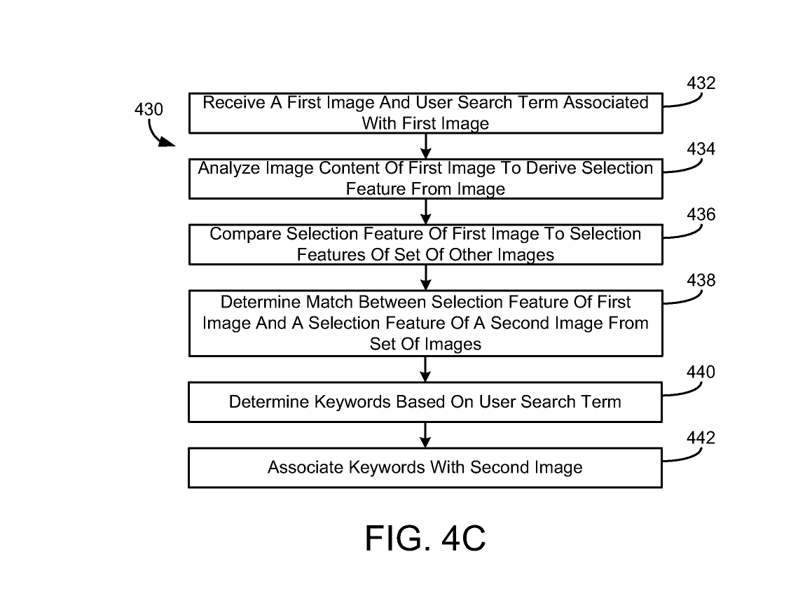

Referring now to FIG. 4A, a flow chart of a process 400 for serving content based on selection features for a campaign is shown in accordance with a described implementation. Process 400 includes receiving an image associated with a particular content (block 402). The image associated with the content may be a image advertisement, a portion of an image advertisement, or an image of another type of content.

Process 400 further includes analyzing the image content of the image to derive a selection feature from the content (block 404). In one implementation, deriving selection features may include using OCR to extract text from the image. Process 400 further includes identifying keywords based on the selection features (block 406). Identifying the keywords is shown in greater detail in FIG. 4B.

Process 400 further includes associating keywords with the content (block 408). Process 400 further includes storing the content and associated keywords for serving in response to a content request (block 410). When a content request is later received, the content request may include one or more keywords that match the keywords of the content. The content may be selected for presentation based on the keywords.

Referring now to FIG. 4B, the step of identifying keywords based on a selection feature (block 406) is shown in greater detail. The process includes determining keywords from the derived selection features (block 420). Determining keywords from the derives selected features may include determining extracted text from the extracted image features and using the text as keywords. The activities of block 420 may be completed by, for example, an OCR module 208.

The process of identifying keywords may further include any number of processing techniques for the extracted text. The process of identifying keywords may further include determining keywords using a clustering technique (block 422). The clustering technique is used to group extracted text and determine a description or keywords from the grouped text. The activities of block 422 may be completed by, for example, a context clustering module 210 or other module configured to interpret text.

The process of identifying keywords further includes determining keywords by determining an image topic (block 424). Determining an image topic may include using extracted text to determine the topic of the image content. The image topic may be determined using a taxonomy. The activities of block 424 may be completed by, for example, a topic module 212 or other module configured to interpret text.

The process of identifying keywords further includes determining keywords by determining complementary terms (block 426). Determining complementary terms may include using extracted text to determine similar terms to the text. The activities of block 426 may be completed by, for example, a complementary term module 214 or other module configured to interpret text.

Referring now to FIG. 4C, the step of identifying keywords based on a selection feautre (block 406) is shown in greater detail according to another example. Process 430 may be used to extract image features from an image in response to an image search performed by a user. For example, when a user performs an image search on a website, the user provides one or more search terms or keywords. The user is provided images based on the input and the user may select an image. If the image is associated with content of a content source, the search terms or keywords that led the user to select the image may be used as selection features.

Process 430 includes receiving a first image and a user search term associated with the first image (block 432). The first image may be an image selected by a user in response to an image search performed by the user, and the user search term may be a search term entered by the user that led the user to select the first image. For example, the image may be the same image that is used in advertisement 300. As another example, the image may be different than the image that is used in advertisement 300, but may have one or more common characteristics. Process 430 further includes analyzing the image content of the first image to derive selection features from the image (block 434). Process 430 further includes comparing the selection feature of the first image to selection features of a set of other images (block 436). This comparison allows a content source (e.g., a content provider) to determine if the image is an image related to the content source's content or is similar to the content source's content. For example, the activities of block 436 may be used to determine if the image is a portion of or is an image advertisement of the content source. Process 430 includes determining a match between the selection feature of the first image and a selection feature of a second image from the set of other images (block 438). The second image may be an image used in content of the content source or related to content of the content source.

Process 430 further includes determining keywords based on the user search terms (block 440) and associating the keywords with the second image (block 442). For example, referring to image advertisement 300 of FIG. 3A, assume that a portion of advertisement 300 showed up in an image search performed by a user when the user entered a search term of “German car.” When the user selects the image, the content source may determine that the image is related to advertisement 300 and therefore may use the search term of “German car” as a keyword and selection feature as described in the present disclosure.

Configurations of Various Exemplary Implementations

Implementations of the subject matter and the operations described in this specification may be implemented in digital electronic circuitry, or in computer software, firmware, or hardware, including the structures disclosed in this specification and their structural equivalents, or in combinations of one or more of them. Implementations of the subject matter described in this specification may be implemented as one or more computer programs, i.e., one or more modules of computer program instructions, encoded on one or more computer storage medium for execution by, or to control the operation of, data processing apparatus. Alternatively or in addition, the program instructions may be encoded on an artificially-generated propagated signal (e.g., a machine-generated electrical, optical, or electromagnetic signal) that is generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium is not a propagated signal, a computer storage medium may be a source or destination of computer program instructions encoded in an artificially-generated propagated signal. The computer storage medium may also be, or be included in, one or more separate components or media (e.g., multiple CDs, disks, or other storage devices). Accordingly, the computer storage medium is both tangible and non-transitory.

The operations described in this disclosure may be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus may include special purpose logic circuitry, e.g., a field programmable gate array (FPGA) or an application-specific integrated circuit (ASIC). The apparatus may also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment may realize various different computing model infrastructures, such as web services, distributed computing and grid computing infrastructures.

The systems and methods of the present disclosure may be completed by any computer program. A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry (e.g., an FPGA or an ASIC).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer may be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), etc.). Devices suitable for storing computer program instructions and data include all forms of non-volatile memory, media and memory devices, including by way of example semiconductor memory devices (e.g., EPROM, EEPROM, and flash memory devices; magnetic disks, e.g., internal hard disks or removable disks; magneto-optical disks; and CD-ROM and DVD-ROM disks). The processor and the memory may be supplemented by, or incorporated in, special purpose logic circuitry.

To provide for interaction with a user, implementations of the subject matter described in this specification may be implemented on a computer having a display device (e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc.) by which the user may provide input to the computer. Other kinds of devices may be used to provide for interaction with a user as well; for example, feedback provided to the user may be any form of sensory feedback (e.g., visual feedback, auditory feedback, or tactile feedback), and input from the user may be received in any form, including acoustic, speech, or tactile input. In addition, a computer may interact with a user by sending documents to and receiving documents from a device that is used by the user; for example, by sending web pages to a web browser on a user's client device in response to requests received from the web browser.

Implementations of the subject matter described in this disclosure may be implemented in a computing system that includes a back-end component (e.g., as a data server), or that includes a middleware component (e.g., an application server), or that includes a front-end component (e.g., a client computer) having a graphical user interface or a Web browser through which a user may interact with an implementation of the subject matter described in this disclosure, or any combination of one or more such back-end, middleware, or front-end components. The components of the system may be interconnected by any form or medium of digital data communication (e.g., a communication network). Examples of communication networks include a LAN and a WAN, an inter-network (e.g., the Internet), and peer-to-peer networks (e.g., ad hoc peer-to-peer networks).

While this specification contains many specific implementation details, these should not be construed as limitations on the scope of any disclosures or of what may be claimed, but rather as descriptions of features specific to particular implementations of particular disclosures. Certain features that are described in this disclosure in the context of separate implementations may also be implemented in combination in a single implementation. Conversely, various features that are described in the context of a single implementation may also be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products embodied on one or more tangible media.

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

Thus, particular implementations of the subject matter have been described. Other implementations are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for serving content based on a selection feature for a campaign, comprising:
receiving an image associated with particular content;
analyzing image content of the image to derive a selection feature from the image, wherein the selection feature is descriptive of image content;
identifying at least one keyword based on the selection feature;
associating the at least one keyword with the particular content; and
storing the particular content and its associated at least one keyword for serving in response to a content request.

2. The method of claim 1, further comprising:
receiving a content request, the content request comprising one of the at least one keyword; and
selecting particular the content to serve responsive to the content request.

3. The method of claim 1, wherein the selection feature relates to the text associated with the image; and
wherein deriving the selection feature from the image includes using optical character recognition (OCR) to extract text from the image.

4. The method of claim 3, wherein determining the at least one keyword comprises using the text extracted from the image.

5. The method of claim 3, wherein determining the at least one keyword comprises:
using a clustering technique on the text associated with the image;
wherein the clustering technique is used to group words from the text and determine a description for the groups of words.

6. The method of claim 3, wherein determining the at least one keyword comprises:
determining a topic of the image based on the text associated with the image;
wherein the topic is a short description of the image.

7. The method of claim 3, wherein determining the at least one keyword comprises:
determining search terms related to the text associated with the image;
wherein the search terms are predetermined terms closely related to the text associated with the image.

8. A computer readable storage medium having instructions stored therein, the instructions being executable by one or more processors to cause the one or more processors to perform operations, comprising:
receiving an image associated with particular content;
analyzing image content of the image to derive a selection feature from the image, wherein the selection feature is descriptive of image content;
identifying at least one keyword based on the selection feature;
associating the at least one keyword with the particular content; and
storing the particular content and its associated at least one keyword for serving in response to a content request.

9. The computer readable storage medium of claim 8, the operations further comprising:
receiving a content request, the content request comprising one of the at least one keyword; and
selecting particular the content to serve responsive to the content request.

10. The computer readable storage medium of claim 8, wherein the selection feature relates to the text associated with the image; and
wherein deriving the selection feature from the image includes using optical character recognition (OCR) to extract text from the image.

11. The computer readable storage medium of claim 10, wherein determining the at least one keyword comprises using the text extracted from the image.

12. The computer readable storage medium of claim 10, wherein determining the at least one keyword comprises:
using a clustering technique on the text associated with the image;
wherein the clustering technique is used to group words from the text and determine a description for the groups of words.

13. The computer readable storage medium of claim 10, wherein determining the at least one keyword comprises:
determining a topic of the image based on the text associated with the image;
wherein the topic is a short description of the image.

14. The computer readable storage medium of claim 10, wherein determining the at least one keyword comprises:
determining search terms related to the text associated with the image;
wherein the search terms are predetermined terms closely related to the text associated with the image.

15. A system for serving content based on a selection feature for a campaign, comprising a processing circuit operable to:
receive an image associated with particular content;
analyze image content of the image to derive a selection feature from the image, wherein the selection feature is descriptive of image content;
identify at least one keyword based on the selection feature;
associate the at least one keyword with the particular content; and
store the particular content and its associated at least one keyword for serving in response to a content request.

16. The system of claim 15, wherein the processing circuit is further operable to:
receive a content request, the content request comprising one of the at least one keyword; and
select particular the content to serve responsive to the content request.

17. The system of claim 15, wherein the selection feature relates to the text associated with the image; and
wherein deriving the selection feature from the image includes using optical character recognition (OCR) to extract text from the image.

18. The system of claim 17, wherein the processing circuit is further operable to:
use a clustering technique on the text associated with the image;
wherein the clustering technique is used to group words from the text and determine a description for the groups of words.

19. The system of claim 17, wherein the processing circuit is further operable to:
determine a topic of the image based on the text associated with the image;
wherein the topic is a short description of the image.

20. The system of claim 17, wherein the processing circuit is further operable to:
determine search terms related to the text associated with the image;
wherein the search terms are predetermined terms closely related to the text associated with the image.

21. A method for serving content based on a selection feature for a campaign, comprising:
receiving a first image and a user search term associated with the first image;
analyzing the image content of the first image to derive a selection feature from the image, wherein the selection feature is descriptive of first image content;
comparing the selection feature of the first image to selection features of a set of other images;
determining a match between the selection feature of the first image and a selection feature of a second image from the set of images;
determining at least one keyword based on the user search term; and
associating the at least one keyword with the second image.

22. The method of claim 21, further comprising:
receiving a content request, the content request comprising one of the at least one keyword; and
selecting particular the content to serve responsive to the content request, wherein the content is associated with the second image.

23. The method of claim 21, wherein the first image is an image displayed to a user as a result from a search engine and the user search term.
